(19) United States
(12) Patent Application Publication
(10) Pub. No.: US 2017/0055235 A1
(43) Pub. Date: Feb. 23, 2017

(54) PROVIDING PRECISION TIMING PROTOCOL (PTP) TIMING AND CLOCK SYNCHRONIZATION FOR WIRELESS MULTIMEDIA DEVICES

(71) Applicant: QUALCOMM Incorporated, San Diego, CA (US)

(72) Inventors: Khosro Mohammad Rabii, San Diego, CA (US); Carlos Horacio Aldana, Mountain View, CA (US); Shivakumar Balasubramanyan, San Diego, CA (US); Padam Lal Kafle, San Diego, CA (US); Fawad Shaukat, San Diego, CA (US); Vijay Naicker Subramaniam, San Diego, CA (US)

(21) Appl. No.: 14/831,994

(22) Filed: Aug. 21, 2015

(51) Int. Cl. H04W 56/00; H04J 3/06; H04W 76/02

(52) U.S. Cl. CPC H04W 56/0015; H04W 76/02; H04J 3/0641

(57) ABSTRACT

Providing Precision Timing Protocol (PTP) timing and clock synchronization for wireless multimedia devices is disclosed. In one aspect, a primary wireless multimedia device comprising a timing synchronization control system is provided. The timing synchronization control system is configured to apply a PTP Best-Master-Clock (BMC) algorithm logic to select a master clock from among a system clock of the primary wireless multimedia device, one of one or more connected wireless multimedia devices, or one of one or more external nodes. If the timing synchronization control system selects the system clock of the primary wireless multimedia device, a clock signal of the system clock is provided to the connected wireless multimedia devices as the master clock. If the timing synchronization control system selects a connected wireless multimedia device or an external node as the master clock, the timing synchronization control system synchronizes the system clock with the master clock.

### BACKGROUND

I. Field of the Disclosure

The technology of the disclosure relates generally to clock synchronization within wireless multimedia systems.

II. Background

As the use of wireless mobile devices, such as smart phones, has proliferated, the number and types of applications available for the wireless mobile devices have increased. One of the most common types of mobile applications provides for the storage and playback of multimedia content. While earlier generations of such applications have focused on music, the use of video files is also being enabled on newer mobile devices as wireless networks provide greater bandwidth and the mobile devices provide greater processing power.

In the earliest aspects of audio- and video-capable mobile devices, a user would typically listen to audio or audio elements within a video file using wired headphones, and later using a wireless headphone set. Many wireless headsets initially were designed to work using the Bluetooth® protocol, and this protocol remains popular among many users. Recently, however, the Wi-Fi Alliance has promulgated the Miracast™ standard, also known as Wi-Fi Display (WFD), to enable wireless screencasting based on underlying 802.11 standards promulgated by the Institute for Electrical and Electronics Engineering (IEEE). Screencasting according to the Miracast standard enables wireless delivery of audio and video to or from desktops, tablets, smart phones, and other devices. For example, a user may echo a display from a phone or tablet onto a television, or share a laptop screen with a conference room projector in real-time, as non-limiting examples.

The ability to provide precision timing and accurate time data, even in poor wireless channel conditions, is becoming increasingly important for next-generation wireless Miracast devices. As non-limiting examples, applications providing timing of real-time events, timed triggers and alarms, multimedia synchronization, ranging, and/or physical proximity and location detection may require precise synchronization of system clocks across multiple wireless devices. However, in the Miracast standard as promulgated by the Wi-Fi Alliance, the role of providing a master clock signal is entrusted to a multimedia source device or to a wirelessly connected multimedia sink device, without regard to the availability of other potentially more accurate time sources. Moreover, conventional multimedia source devices and multimedia sink devices employ application processors that execute a high-level operating system (HLOS) that may be subject to unpredictable concurrency workloads and unplanned schedules and preemption. Consequently, such conventional multimedia source devices and multimedia sink devices may be unable to implement more accurate timing and synchronization protocols such as the Precision Timing Protocol (PTP).

### SUMMARY OF THE DISCLOSURE

Aspects disclosed in the detailed description include providing Precision Timing Protocol (PTP) timing and clock synchronization for wireless multimedia devices. In this regard, in some aspects, a primary wireless multimedia device (e.g., a multimedia source device or a multimedia sink device, as non-limiting examples, that is responsible for selecting a master clock) is provided. The primary wireless multimedia device comprises a timing synchronization control system. When wirelessly connected to one or more connected wireless multimedia devices, the timing synchronization control system applies a PTP Best-Master-Clock (BMC) algorithm logic to select a master clock. The master clock may be a system clock of the primary wireless multimedia device, one of the one or more connected wireless multimedia devices, or one of one or more external nodes. If the timing synchronization control system selects the system clock of the primary wireless multimedia device, a clock signal of the system clock is provided to the connected wireless multimedia devices as the master clock. If the timing synchronization control system selects one of the connected wireless multimedia devices or one of the external nodes as the master clock, the timing synchronization control system synchronizes the system clock of the primary wireless multimedia device with the master clock.

Some aspects may also provide that the timing synchronization control system determines whether the system clock is synchronized with the master clock within a synchronization tolerance range. If so, an application processing layer may render a multimedia stream. If the system clock is determined not to be synchronized with the master clock, the timing synchronization control system may provide a notification of loss of synchronization to the application processing layer, which may cease the rendering of the multimedia stream.

In this regard, in one aspect, a primary wireless multimedia device is provided. The primary wireless multimedia device comprises a wireless controller communicatively coupled to an antenna. The wireless controller is configured to establish one or more wireless connections with a corresponding one or more connected wireless multimedia devices. The primary wireless multimedia device further comprises a system clock, and a timing synchronization control system that is coupled to the wireless controller and the system clock. The timing synchronization control system is configured to apply a PTP BMC algorithm logic to select dynamically a master clock from among the system clock, the one or more connected wireless multimedia devices, and one or more external nodes. The timing synchronization control system is further configured to, responsive to selecting the system clock as the master clock, provide a clock signal of the system clock as the master clock to the one or more connected wireless multimedia devices. The timing synchronization control system is also configured to, responsive to selecting a connected wireless multimedia device of the one or more connected wireless multimedia devices or an external node of the one or more external nodes as the master clock, synchronize the system clock with the master clock.

In another aspect, a primary wireless multimedia device is provided. The primary wireless multimedia device comprises a means for applying a PTP BMC algorithm logic to select dynamically a master clock from among a system clock of the primary wireless multimedia device, one or more connected wireless multimedia devices, and one or more external nodes. The primary wireless multimedia device further comprises a means for providing a clock signal of the system clock of the primary wireless multimedia device as the master clock to the one or more connected wireless multimedia devices, responsive to selecting the system clock as the master clock. The primary wireless multimedia device also comprises a means for synchronizing the system clock of the primary wireless multimedia device with the master clock, responsive to selecting a connected wireless multimedia device of the one or more connected wireless multimedia devices or an external node of the one or more external nodes as the master clock.

In another aspect, a method for providing timing synchronization control for wireless multimedia devices is provided. The method comprises applying, by a timing synchronization control system of a primary wireless multimedia device, a PTP BMC algorithm logic to select dynamically a master clock from among a system clock of the primary wireless multimedia device, one or more connected wireless multimedia devices, and one or more external nodes. The method further comprises, responsive to selecting the system clock as the master clock, providing a clock signal of the system clock of the primary wireless multimedia device as the master clock to the one or more connected wireless multimedia devices. The method also comprises, responsive to selecting a connected wireless multimedia device of the one or more connected wireless multimedia devices or an external node of the one or more external nodes as the master clock, synchronizing the system clock of the primary wireless multimedia device with the master clock.

### BRIEF DESCRIPTION OF THE FIGURES

FIG. 1 is a block diagram of an exemplary wireless multimedia device comprising a multimedia source device for providing wireless distribution of a multimedia stream;

FIG. 2 is a block diagram of an exemplary wireless multimedia device comprising a multimedia sink device for receiving and rendering a multimedia stream;

FIG. 3 is an illustration of an exemplary aspect of a simplified multimedia system including aspects of the multimedia source device of FIG. 1 and the multimedia sink device of FIG. 2;

FIG. 4 is a block diagram of a primary wireless multimedia device including a timing synchronization control system for providing Precision Timing Protocol (PTP) timing and clock synchronization;

FIG. 5 is an illustration of exemplary wireless multimedia devices and external nodes from which the timing synchronization control system of FIG. 4 may select a master clock; and

FIGS. 6A and 6B are flowcharts illustrating exemplary operations of the timing synchronization control system of FIG. 4 for providing PTP timing and clock synchronization.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include providing Precision Timing Protocol (PTP) timing and clock synchronization for wireless multimedia devices. In this regard, in some aspects, a primary wireless multimedia device (e.g., a multimedia source device or a multimedia sink device, as non-limiting examples, that is responsible for selecting a master clock) is provided. The primary wireless multimedia device comprises a timing synchronization control system. When wirelessly connected to one or more connected wireless multimedia devices, the timing synchronization control system applies a PTP Best-Master-Clock (BMC) algorithm logic to select a master clock. The master clock may be a system clock of the primary wireless multimedia device, one of the one or more connected wireless multimedia devices, or one of one or more external nodes. If the timing synchronization control system selects the system clock of the primary wireless multimedia device, a clock signal of the system clock is provided to the connected wireless multimedia devices as the master clock. If the timing synchronization control system selects one of the connected wireless multimedia devices or one of the external nodes as the master clock, the timing synchronization control system synchronizes the system clock of the primary wireless multimedia device with the master clock.

Some aspects may also provide that the timing synchronization control system determines whether the system clock is synchronized with the master clock within a synchronization tolerance range. If so, an application processing layer may render a multimedia stream. If the system clock is determined not to be synchronized with the master clock, the timing synchronization control system may provide a notification of loss of synchronization to the application processing layer, which may cease the rendering of the multimedia stream.

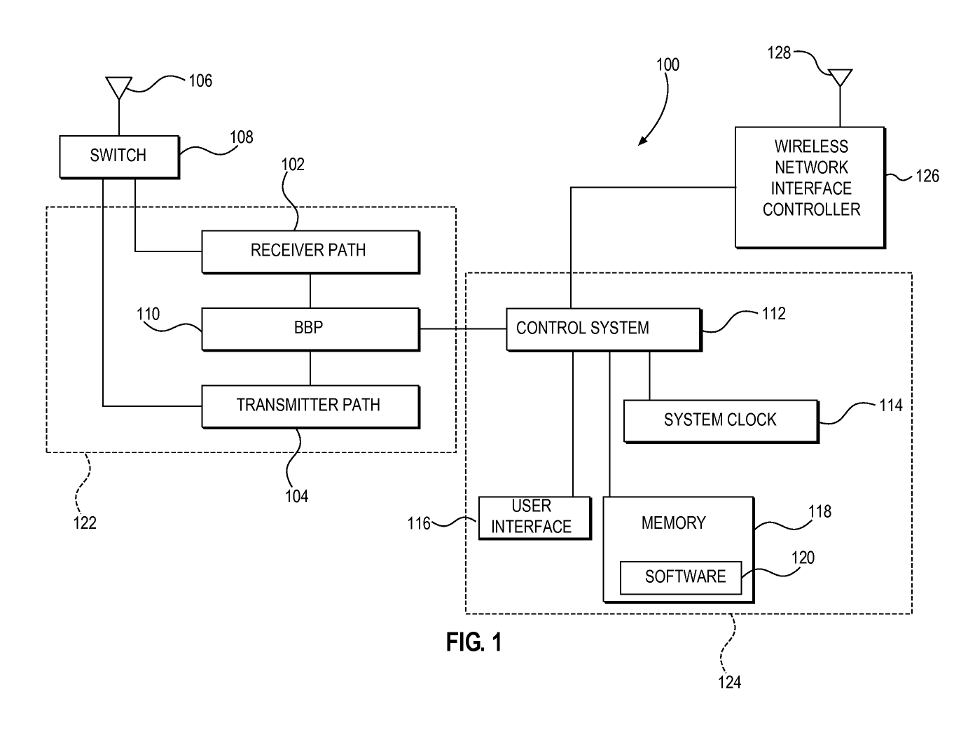

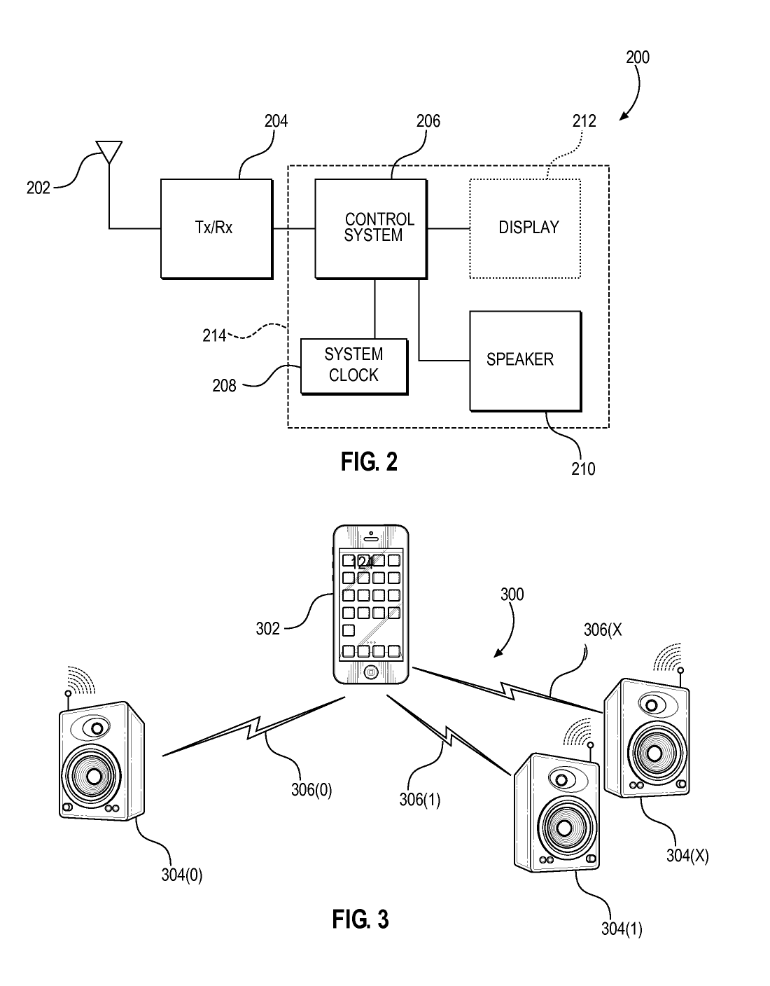

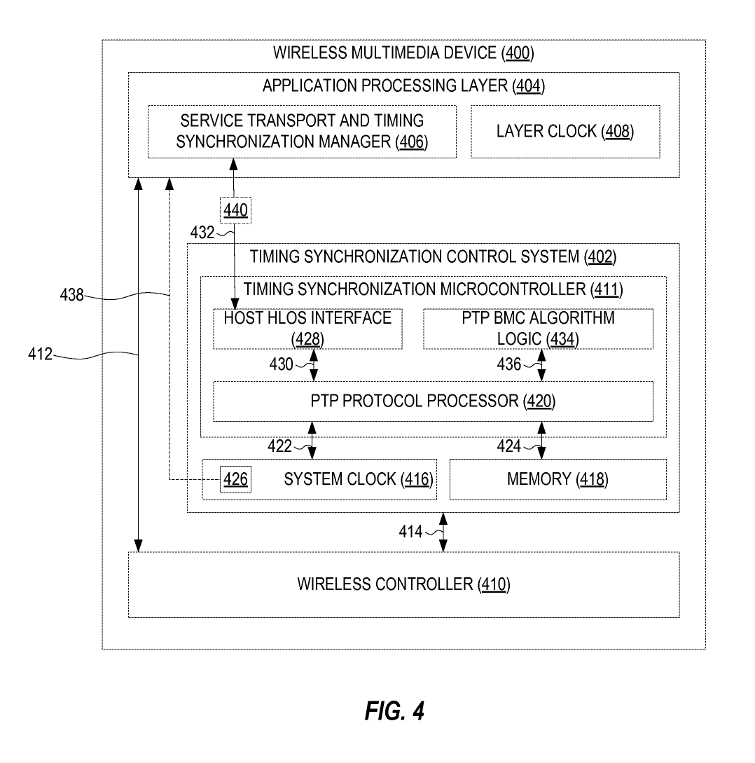

Before discussing providing PTP timing and clock synchronization for wireless multimedia devices, exemplary devices and point-to-multipoint multimedia systems are described. In this regard, FIGS. 1-3 are provided. FIG. 1 illustrates an exemplary wireless multimedia device acting as a multimedia source device for providing wireless distribution of a multimedia stream, while FIG. 2 illustrates elements of an exemplary wireless multimedia device acting as a multimedia sink device. FIG. 3 illustrates an exemplary wireless multimedia system that may incorporate the multimedia source device of FIG. 1 and the multimedia sink device of FIG. 2.

In FIG. 1, a multimedia source device 100 is provided. As used herein, the term “multimedia source device” refers to a wireless multimedia device for streaming a multimedia stream to one or more multimedia sink devices for rendition. The multimedia source device 100 may comprise, as non-limiting examples, a smart phone or tablet, or other mobile computing device. The multimedia source device 100 of FIG. 1 includes a receiver path 102, a transmitter path 104, an antenna 106, a switch 108, a baseband processor (BBP) 110, a control system 112, a system clock 114 for generating clock signals (not shown), a frequency synthesizer (not shown), a user interface 116, and memory 118 with software 120 stored therein. It is to be understood that the elements of the multimedia source device 100 are shown for illustrative purposes only, and that some aspects of the multimedia source device 100 may include more or fewer elements than shown in FIG. 1.

In exemplary operation, the receiver path 102 of the multimedia source device 100 may receive information-bearing radio frequency (RF) signals from one or more remote transmitters provided by a base station (not shown), such as a cellular network base station. A low noise amplifier (not shown) may amplify the signals. A filter (not shown) may minimize broadband interference in the received signals, while down-conversion circuitry (not shown) may down-convert the filtered signals into intermediate or baseband frequency signals, which then may be digitized into one or more digital streams by digitization circuitry (not shown). In some aspects, the receiver path 102 may use one or more mixing frequencies generated by the frequency synthesizer. The BBP 110 processes the digitized received signals to extract the information (e.g., data bits, as a non-limiting example) conveyed in the signals. As such, the BBP 110 may be implemented as one or more digital signal processors (DSPs), as a non-limiting example.

With continued reference to FIG. 1, on the transmit side, the BBP 110 may receive digitized data (representing, e.g., voice, data, or control information, as non-limiting examples) from the control system 112, which the BBP 110 then encodes for transmission. The encoded data is output to the transmitter path 104, where it may be used by a modulator (not shown) to modulate a carrier signal at a desired transmit frequency. An RF power amplifier (not shown) may amplify the modulated carrier signal to a level appropriate for transmission, and may deliver the amplified and modulated carrier signal to the antenna 106 through the switch 108. Collectively, the receiver path 102, the transmitter path 104, and the frequency synthesizer may be considered a wireless modem 122.

Referring still to FIG. 1, a user (not shown) may interact with the multimedia source device 100 via the user interface 116. In some aspects, the user interface 116 may comprise one or more microphones and/or speakers, a keypad, and/or a display, as non-limiting examples. Some aspects may provide that audio information encoded in the received signal is recovered by the BBP 110, and converted into an analog signal suitable for driving a speaker (not shown). In some aspects, a keypad and display of the user interface 116 may enable the user to interact with the multimedia source device 100. For example, the keypad and display may enable the user to input numbers to be dialed, access address book information, and/or monitor call progress information, as non-limiting examples. The memory 118 may have the software 120 therein as noted above, which may effectuate exemplary aspects of the present disclosure. Audio and/or video content may be stored in the memory 118, and/or may be retrieved from a remote source (e.g., streamed via a network such as the internet via the wireless modem 122). In normal operation, the user may view video content through a display provided by the user interface 116, and/or may listen to audio content through speakers provided by the user interface 116. The control system 112, the system clock 114, the user interface 116, and the memory 118 may be referred to collectively as an application processing layer 124 of the multimedia source device 100. The application processing layer 124 may employ a high-level operating system (HLOS) (not shown) to provide the functionality discussed above.

With further reference to FIG. 1, the multimedia source device 100 may include a wireless network interface controller 126 with its own antenna 128. In some aspects, the wireless network interface controller 126 may operate according to a known protocol, such as those published by the Institute for Electrical and Electronics Engineering (IEEE) within the 802.11 family and as promoted by the Wi-Fi Alliance. These protocols may include wireless local area network (WLAN) techniques, popularly known as Wi-Fi systems, that may utilize contention-based carrier sense multiple access with collision avoidance (CSMA/CA) mechanisms to access a wireless medium. In some aspects, the wireless network interface controller 126 may have its own transceiver (not shown) having its own transmitter path and its own receiver path (neither shown) and operating with its own BBP, while some aspects may provide that the wireless network interface controller 126 uses the BBP 110. According to some aspects, the multimedia source device 100 may be configured to interoperate with one or more other multimedia source devices and/or multimedia sink devices via the wireless network interface controller 126 and the antenna 128.

According to protocols promulgated by the Wi-Fi Alliance, such as Miracast™ (also referred to as Wi-Fi Display or WFD), the multimedia source device 100 may stream audio and/or video to a remote multimedia sink device, such as a speaker and/or large screen display. As used herein, the term “multimedia sink device” refers to a wireless multimedia device for receiving a multimedia stream from a multimedia source device, and rendering the multimedia stream. In this regard, a multimedia sink device 200 is illustrated in FIG. 2. In the example of FIG. 2, wireless signals are received and transmitted through an antenna 202 coupled to a transceiver (Tx/Rx) 204. While not illustrated, the transceiver 204 may include a receiver path, a transmitter path, and a BBP having functionality corresponding to the receiver path 102, the transmitter path 104, and the BBP 110, respectively, of FIG. 1. A control system 206 is provided to coordinate the activities of the multimedia sink device 200 for receiving and rendering a multimedia stream (not shown). The control system 206 is operatively coupled to the transceiver 204, and may receive instructions embedded within the wireless signals received by the transceiver 204. The control system 206 is also coupled to a system clock 208, which may provide a clock signal (not shown) to the control system 206. The control system 206 may further be coupled to one or more output devices, including but not limited to a speaker 210 and/or a display 212. In exemplary aspects, the multimedia sink device 200 may be a television with the display 212 and speakers 210, or one speaker 210 among a plurality of speakers 210 in, for example, a surround sound system. Collectively, the control system 206, the system clock 208, the speaker 210, and the display 212 may be referred to as an application processing layer 214 of the multimedia sink device 200. The application processing layer 214 may make use of a HLOS (not shown) to provide the functionality discussed above.

FIG. 3 illustrates an exemplary wireless multimedia system 300 that may provide streaming of multimedia content from a multimedia source device to multiple multimedia sink devices. As seen in FIG. 3, the wireless multimedia system 300 may provide a multimedia source device 302, which in some aspects may comprise a wireless multimedia device such as the multimedia source device 100 of FIG. 1. The wireless multimedia system 300 may further include a plurality of multimedia sink devices 304(0)-304(X), each of which may comprise a wireless multimedia device such as the multimedia sink device 200 of FIG. 2. The multimedia source device 302 communicates with the multimedia sink devices 304(0)-304(X) through wireless signals 306(0)-306(X), respectively. In some aspects, the wireless signals 306(0)-306(X) may conform to one of the IEEE 802.11 standards operating under the Wi-Fi designation.

In a conventional wireless multimedia system such as the wireless multimedia system 300, communications among the multimedia source device 302 and the multimedia sink devices 304(0)-304(X) are synchronized using a clock signal provided by a master clock (not shown). In the Miracast standard as promulgated by the Wi-Fi Alliance, the role of providing a master clock signal is entrusted to the multimedia source device 302 or to one of the multimedia sink devices 304(0)-304(X), without regard to the availability of other potentially more accurate time sources. For example, the multimedia source device 302 and/or one or more of the multimedia sink devices 304(0)-304(X) may be connected via a local area network (LAN) (not shown) or a wide area network (WAN) (not shown) to one or more external nodes (not shown) capable of providing a more accurate clock signal. However, due to the unpredictable workload of the HLOS executed by each of the multimedia source device 302 and the multimedia sink devices 304(0)-304(X), implementation of accurate timing and synchronization protocols such as PTP for selecting a master clock may not be practicable.

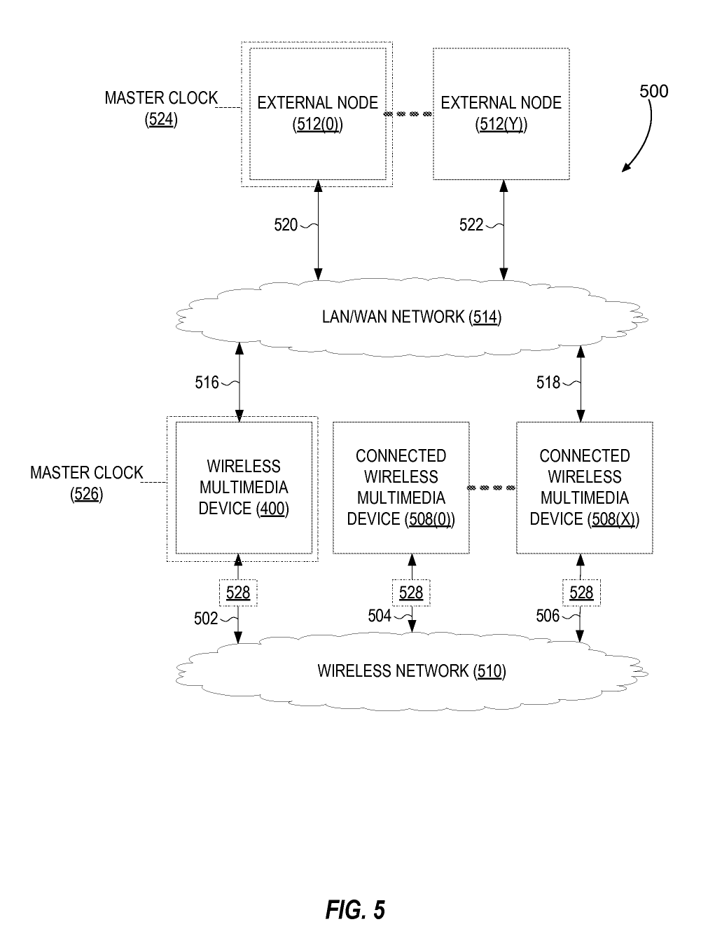

In this regard, FIG. 4 illustrates an exemplary primary wireless multimedia device 400 including a timing synchronization control system 402 for providing PTP timing and clock synchronization. As used herein, the term “primary wireless multimedia device” refers to a multimedia source device or a multimedia sink device that has been tasked with identifying an appropriate master clock. The primary wireless multimedia device 400 provides an application processing layer 404 having functionality corresponding to the application processing layer 124 of FIG. 1 and/or the application processing layer 214 of FIG. 2. The application processing layer 404 in this example includes a service transport and timing synchronization manager 406 for communicating with the timing synchronization control system 402. The application processing layer 404 of FIG. 4 also includes a layer clock 408, which may be used to provide clock signals (not shown) for timing and synchronization within the application processing layer 404. In some aspects, the application processing layer 404 may provide functionality as described herein by executing an HLOS (not shown). It is to be understood that the application processing layer 404 according to some aspects may include fewer or additional elements than those illustrated in FIG. 4.

The primary wireless multimedia device 400 also provides a wireless controller 410 having functionality corresponding to the wireless network interface controller 126 and the antenna 128 of FIG. 1 and/or the transceiver 204 and the antenna 202 of FIG. 2. The wireless controller 410 is communicatively coupled to the application processing layer 404 and the timing synchronization control system 402, as indicated by bidirectional arrows 412 and 414, respectively. In this manner, the timing synchronization control system 402 may communicate via PTP messages with other devices connected to the primary wireless multimedia device 400 via the wireless controller 410.

In the example of FIG. 4, the timing synchronization control system 402 is implemented using a timing synchronization microcontroller 411, a system clock 416, and memory 418. The timing synchronization microcontroller 411 according to some aspects may execute a real-time operating system (RTOS). The system clock 416 and the memory 418 are communicatively coupled to a PTP protocol processor 420 of the timing synchronization microcontroller 411, as indicated by bidirectional arrows 422 and 424, respectively. The system clock 416 generates a clock signal 426. The PTP protocol processor 420 is also communicatively coupled to a host HLOS interface 428, as indicated by bidirectional arrow 430. The host HLOS interface 428 enables communications between the timing synchronization control system 402 and the service transport and timing synchronization manager 406 of the application processing layer 404, as shown by bidirectional arrow 432.

The PTP protocol processor 420 is further communicatively coupled to a PTP BMC algorithm logic 434 implemented by the timing synchronization microcontroller 411, as indicated by bidirectional arrow 436. The PTP BMC algorithm logic 434 employs the PTP BMC algorithm for selecting a best master clock among the primary wireless multimedia device 400 and other connected wireless multimedia devices (not shown) and/or external nodes (not shown). In some aspects, the PTP BMC algorithm logic 434 may base its selection of a master clock on clock attributes such as a user-defined priority of a clock, a class to which the clock is assigned, an accuracy of the clock, and/or a variability of the clock, as non-limiting examples.

The timing synchronization control system 402 is configured to employ the PTP BMC algorithm logic 434 to select a master clock from among the system clock 416, one or more connected wireless multimedia devices (not shown) to which the primary wireless multimedia device 400 is connected, and one or more external nodes (not shown). As noted above, the one or more external nodes may include devices connected to the primary wireless multimedia device 400 and/or to one or more of the connected wireless multimedia devices via a LAN or a WAN, as non-limiting examples. If the PTP BMC algorithm logic 434 of the timing synchronization control system 402 selects the system clock 416 as the master clock, the timing synchronization control system 402 provides the clock signal 426 of the system clock 416 to the one or more connected wireless multimedia devices as the master clock for subsequent multimedia operations. However, if the PTP BMC algorithm logic 434 of the timing synchronization control system 402 selects one of the one or more connected wireless multimedia devices or one of the one or more external nodes as the master clock, the timing synchronization control system 402 synchronizes the system clock 416 to the selected master clock. In aspects in which the primary wireless multimedia device 400 is a multimedia source device, the primary wireless multimedia device 400 may then provide a multimedia stream (not shown) to the connected wireless multimedia devices based on the system clock 416. According to aspects in which the primary wireless multimedia device 400 is a multimedia sink device, the primary wireless multimedia device 400 may render the multimedia stream based on the system clock 416.

In some aspects, the timing synchronization control system 402 may also provide the clock signal 426 to the application processing layer 404 of the primary wireless multimedia device 400 for synchronization of the layer clock 408, as indicated by arrow 438. Note that at this point, the system clock 416 has either been selected as the master clock, or has been synchronized with the master clock. In this manner, the timing synchronization control system 402 may ensure that the system clock 416 and the layer clock 408 used by the application processing layer 404 are synchronized to a single master clock.

In aspects of the primary wireless multimedia device 400 in which the system clock 416 is synchronized to the master clock, maintaining synchronization with the master clock may be important to proper rendition of the multimedia stream by a multimedia sink device. Accordingly, in such aspects, the timing synchronization control system 402 may be further configured to determine periodically whether the system clock 416 is synchronized with the master clock within a specified synchronization threshold range (e.g., a range of tolerable variance between the system clock 416 and the master clock, as a non-limiting example). If the timing synchronization control system 402 determines that the system clock 416 has maintained synchronization with the master clock within the synchronization threshold range, the application processing layer 404 renders the multimedia stream based on the system clock 416. However, if the timing synchronization control system 402 determines that the system clock 416 is no longer synchronized with the master clock within the synchronization threshold range, the timing synchronization control system 402 may provide a notification 440 of loss of synchronization to the application processing layer 404. The notification 440 of loss of synchronization indicates to the application processing layer 404 that the system clock 416 is no longer synchronized properly with the master clock. In some aspects, the application processing layer 404 may then cease the rendering of the multimedia stream in response to receiving the notification 440 of loss of synchronization.

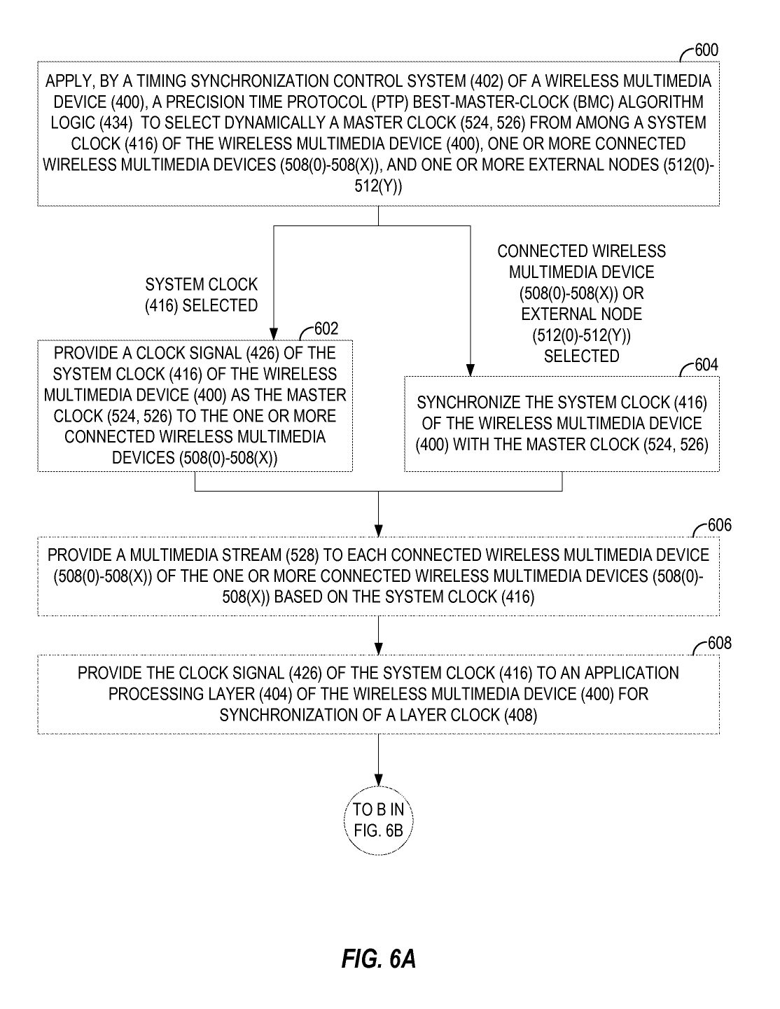

To illustrate selection of a master clock by the timing synchronization control system 402 of FIG. 4 from among multiple exemplary wireless multimedia devices and external nodes, FIG. 5 is provided. As seen in an exemplary network configuration 500 of FIG. 5, the primary wireless multimedia device 400 of FIG. 4 has established wireless connections 502, 504, 506 with connected wireless multimedia devices 508(0)-508(X), respectively, via a wireless network 510. In some aspects, the wireless network 510 may comprise a Wi-Fi network. The primary wireless multimedia device 400, the connected wireless multimedia device 508(X), and external nodes 512(0)-512(Y) are also connected to a LAN/WAN network 514 via connections 516, 518, 520, and 522, respectively. In some aspects, the external nodes 512(0)-512(Y) include devices supporting time synchronization via PTP. It is to be understood that the exemplary network configuration 500 shown in FIG. 5 is for illustration only, and that other network configurations 500 may include more or fewer connected wireless multimedia devices 508(0)-508(X) and external nodes 512(0)-512(Y) and/or network connections.

According to some aspects, the primary wireless multimedia device 400 may select an external node, such as the external node 512(0), as a master clock 524 in the manner described above. In such aspects, the primary wireless multimedia device 400 would then synchronize the system clock 416 of FIG. 4 with the external node 512(0). This may enable the primary wireless multimedia device 400 to obtain a more accurate clock signal than may be available from the system clock 416 or from the connected wireless multimedia devices 508(0)-508(X). Some aspects may provide that one of the primary wireless multimedia device 400 and the connected wireless multimedia devices 508(0)-508(X) connected to the wireless network 510 may be selected as a master clock. In the example of FIG. 5, the primary wireless multimedia device 400 may be selected as a master clock 526, and may then provide the clock signal 426 of the system clock 416 as the master clock 526 to the connected wireless multimedia devices 508(0)-508(X).

After the master clock 524, 526 is selected and synchronization has taken place, a multimedia stream 528 may be streamed over the wireless network 510. In aspects in which the primary wireless multimedia device 400 is a multimedia source device, the primary wireless multimedia device 400 may stream the multimedia stream 528 to the connected wireless multimedia devices 508(0)-508(X). In aspects in which the primary wireless multimedia device 400 is a multimedia sink device, the primary wireless multimedia device 400 may receive and render the multimedia stream 528.

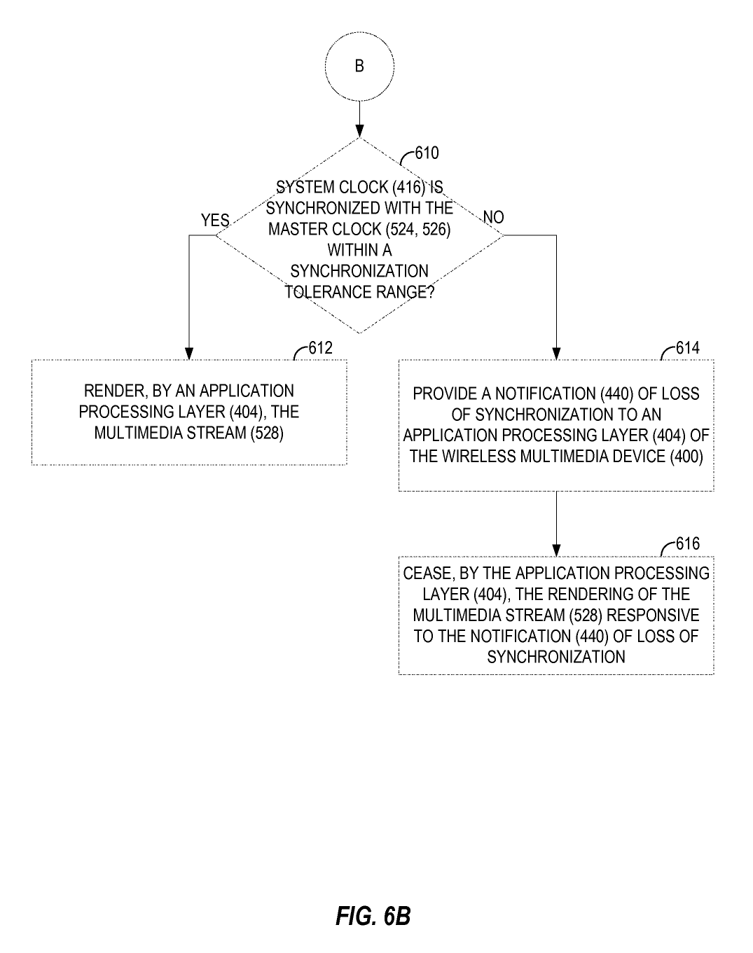

FIGS. 6A and 6B are flowcharts illustrating exemplary operations of the timing synchronization control system 402 of FIG. 4 for providing PTP timing and clock synchronization. For the sake of brevity, elements of FIGS. 4 and 5 are referenced in describing FIGS. 6A and 6B. Operations in FIG. 6A begin with the timing synchronization control system 402 of the primary wireless multimedia device 400 applying the PTP BMC algorithm logic 434 to select dynamically a master clock 524, 526 from among the system clock 416 of the primary wireless multimedia device 400, one or more connected wireless multimedia devices 508(0)-508(X), and one or more external nodes 512(0)-512(Y) (block 600). In this regard, the timing synchronization control system 402 may be referred to herein as “a means for applying a PTP BMC algorithm logic to select dynamically a master clock.” If the timing synchronization control system 402 selects the system clock 416 as the master clock 524, 526, the timing synchronization control system 402 provides a clock signal 426 of the system clock 416 of the primary wireless multimedia device 400 as the master clock 524, 526 to the one or more connected wireless multimedia devices 508(0)-508(X) (block 602). The timing synchronization control system 402 may thus be referred to herein as “a means for providing a clock signal of the system clock of the primary wireless multimedia device as the master clock to the one or more connected wireless multimedia devices.” However, if the timing synchronization control system 402 selects one of the one or more connected wireless multimedia devices 508(0)-508(X) or one of the one or more external nodes 512(0)-512(Y) as the master clock 524, 526, the timing synchronization control system 402 synchronizes the system clock 416 of the primary wireless multimedia device 400 with the master clock 524, 526 (block 604). Accordingly, the timing synchronization control system 402 may be referred to herein as “a means for synchronizing the system clock of the primary wireless multimedia device with the master clock.”

In some aspects in which the primary wireless multimedia device 400 is a multimedia source device, the primary wireless multimedia device 400 may then provide the multimedia stream 528 to each connected wireless multimedia device 508(0)-508(X) of the one or more connected wireless multimedia devices 508(0)-508(X) based on the system clock 416 (block 606). Some aspects may provide that the timing synchronization control system 402 may provide the clock signal 426 of the system clock 416 to the application processing layer 404 of the primary wireless multimedia device 400 for synchronization of the layer clock 408 (block 608). The timing synchronization control system 402 may thus be referred to herein as “a means for providing the clock signal of the system clock to an application processing layer of the primary wireless multimedia device for synchronization of a layer clock.” It is to be understood that the operations of blocks 606 and 608 may occur in an order other than that illustrated in FIG. 6A. Processing then resumes at block 610 of FIG. 6B.

Referring now to FIG. 6B, some aspects of the timing synchronization control system 402 of the primary wireless multimedia device 400 may determine whether the system clock 416 is synchronized with the master clock 524, 526 within a synchronization tolerance range (block 610). Accordingly, the timing synchronization control system 402 may be referred to herein as “a means for determining whether the system clock is synchronized with the master clock within a synchronization tolerance range.” If the system clock 416 is determined to be synchronized with the master clock 524, 526 within the synchronization tolerance range, the application processing layer 404 may render the multimedia stream 528 (block 612). In this regard, the application processing layer 404 may be referred to herein as “a means for rendering a multimedia stream.” However, if it is determined at decision block 610 that the system clock 416 is not synchronized with the master clock 524, 526 within the synchronization tolerance range, the timing synchronization control system 402 may provide a notification 440 of loss of synchronization to the application processing layer 404 of the primary wireless multimedia device 400 (block 614). In this regard, the timing synchronization control system 402 may be referred to herein as “a means for providing a notification of loss of synchronization to an application processing layer of the primary wireless multimedia device.” The application processing layer 404 in some aspects may then cease the rendering of the multimedia stream 528 responsive to the notification 440 of loss of synchronization (block 616). The application processing layer 404 may thus be referred to herein as “a means for ceasing the rendering of the multimedia stream responsive to the notification of loss of synchronization.”

Providing PTP timing and clock synchronization for wireless multimedia devices according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a smart phone, a tablet, a phablet, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, and an automobile.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a DSP, an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A primary wireless multimedia device, comprising:
a wireless controller communicatively coupled to an antenna, the wireless controller configured to establish one or more wireless connections with a corresponding one or more connected wireless multimedia devices;
a system clock; and
a timing synchronization control system coupled to the wireless controller and the system clock, the timing synchronization control system configured to:
apply a Precision Timing Protocol (PTP) Best-Master-Clock (BMC) algorithm logic to select dynamically a master clock from among the system clock, the one or more connected wireless multimedia devices, and one or more external nodes;
responsive to selecting the system clock as the master clock, provide a clock signal of the system clock as the master clock to the one or more connected wireless multimedia devices; and
responsive to selecting a connected wireless multimedia device of the one or more connected wireless multimedia devices or an external node of the one or more external nodes as the master clock, synchronize the system clock with the master clock.

2. The primary wireless multimedia device of claim 1, further comprising an application processing layer comprising a layer clock;
wherein the timing synchronization control system is further configured to provide the clock signal of the system clock to the application processing layer for synchronization of the layer clock.

3. The primary wireless multimedia device of claim 1, wherein:
the primary wireless multimedia device comprises a multimedia sink device comprising an application processing layer; and
the timing synchronization control system is further configured to:
determine whether the system clock is synchronized with the master clock within a synchronization tolerance range; and
responsive to determining that the system clock is not synchronized with the master clock within the synchronization tolerance range, provide a notification of loss of synchronization to the application processing layer; and
the application processing layer configured to render a multimedia stream responsive to the timing synchronization control system determining that the system clock is synchronized with the master clock within the synchronization tolerance range.

4. The primary wireless multimedia device of claim 3, wherein the application processing layer is configured to cease the rendering of the multimedia stream responsive to receiving the notification of loss of synchronization from the timing synchronization control system.

5. The primary wireless multimedia device of claim 1, wherein the primary wireless multimedia device comprises a multimedia source device configured to provide a multimedia stream to each connected wireless multimedia device of the one or more connected wireless multimedia devices based on the system clock.

6. The primary wireless multimedia device of claim 1, wherein the wireless controller is configured to establish the one or more wireless connections with the corresponding one or more connected wireless multimedia devices based on a Miracast protocol.

7. The primary wireless multimedia device of claim 1 integrated into an integrated circuit (IC).

8. The primary wireless multimedia device of claim 1 integrated into a device selected from the group consisting of: a set top box, an entertainment unit, a navigation device, a communications device, a fixed location data unit, a mobile location data unit, a mobile phone, a cellular phone, a smart phone, a tablet, a phablet, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, and an automobile.

9. A primary wireless multimedia device, comprising:
a means for applying a Precision Timing Protocol (PTP) Best-Master-Clock (BMC) algorithm logic to select dynamically a master clock from among a system clock of a primary wireless multimedia device, one or more connected wireless multimedia devices, and one or more external nodes;
a means for providing a clock signal of the system clock of the primary wireless multimedia device as the master clock to the one or more connected wireless multimedia devices, responsive to selecting the system clock as the master clock; and
a means for synchronizing the system clock of the primary wireless multimedia device with the master clock, responsive to selecting a connected wireless multimedia device of the one or more connected wireless multimedia devices or an external node of the one or more external nodes as the master clock.

10. The primary wireless multimedia device of claim 9, further comprising a means for providing the clock signal of the system clock to an application processing layer of the primary wireless multimedia device for synchronization of a layer clock.

11. The primary wireless multimedia device of claim 9, wherein the primary wireless multimedia device comprises a multimedia sink device;
the primary wireless multimedia device further comprising:
a means for determining whether the system clock is synchronized with the master clock within a synchronization tolerance range;
a means for rendering a multimedia stream, responsive to determining that the system clock is synchronized with the master clock within the synchronization tolerance range; and
a means for providing a notification of loss of synchronization to an application processing layer of the primary wireless multimedia device, responsive to determining that the system clock is not synchronized with the master clock within the synchronization tolerance range.

12. The primary wireless multimedia device of claim 11, further comprising a means for ceasing the rendering of the multimedia stream responsive to the notification of loss of synchronization.

13. The primary wireless multimedia device of claim 9, wherein the primary wireless multimedia device comprises a multimedia source device;
the primary wireless multimedia device further comprising a means for providing a multimedia stream to each connected wireless multimedia device of the one or more connected wireless multimedia devices based on the system clock.

14. A method for providing timing synchronization control for wireless multimedia devices, comprising:
applying, by a timing synchronization control system of a primary wireless multimedia device, a Precision Timing Protocol (PTP) Best-Master-Clock (BMC) algorithm logic to select dynamically a master clock from among a system clock of the primary wireless multimedia device, one or more connected wireless multimedia devices, and one or more external nodes;
responsive to selecting the system clock as the master clock, providing a clock signal of the system clock of the primary wireless multimedia device as the master clock to the one or more connected wireless multimedia devices; and
responsive to selecting a connected wireless multimedia device of the one or more connected wireless multimedia devices or an external node of the one or more external nodes as the master clock, synchronizing the system clock of the primary wireless multimedia device with the master clock.

15. The method of claim 14, further comprising providing the clock signal of the system clock to an application processing layer of the primary wireless multimedia device for synchronization of a layer clock.

16. The method of claim 14, wherein the primary wireless multimedia device comprises a multimedia sink device;
the method further comprising:
determining whether the system clock is synchronized with the master clock within a synchronization tolerance range;
responsive to determining that the system clock is synchronized with the master clock within the synchronization tolerance range, rendering, by an application processing layer of the primary multimedia device, a multimedia stream; and
responsive to determining that the system clock is not synchronized with the master clock within the synchronization tolerance range, providing a notification of loss of synchronization to the application processing layer of the primary wireless multimedia device.

17. The method of claim 16, further comprising ceasing, by the application processing layer, the rendering of the multimedia stream responsive to the notification of loss of synchronization.

18. The method of claim 14, wherein the primary wireless multimedia device comprises a multimedia source device;
the method further comprising providing a multimedia stream to each connected wireless multimedia device of the one or more connected wireless multimedia devices based on the system clock.

19. The method of claim 14, wherein the primary wireless multimedia device is wirelessly connected to the one or more connected wireless multimedia devices based on a Miracast protocol.
